(19) United States
(12) Patent Application Publication
(10) Pub. No.: US 2021/0199634 A1
(43) Pub. Date: Jul. 1, 2021

(54) RAPID DETECTION METHOD OF SULFIDE CONTENT

(71) Applicant: INDUSTRIAL TECHNOLOGY RESEARCH INSTITUTE, Hsinchu (TW)

(72) Inventors: Win-Lone LIN, New Taipei City (TW); Huan-Yi HUNG, Xiushui Township (TW); Chien-Wei LU, Hsinchu City (TW); Han-Wen CHU, Hsinchu City (TW); Hsiu-Li SU, Hsinchu City (TW); Yueh-Hsing LI, Taipei City (TW); Chong-You CHEN, Taichung City (TW); Ting-Yu TSAI, Toufen City (TW)

(73) Assignee: INDUSTRIAL TECHNOLOGY RESEARCH INSTITUTE, Hsinchu (TW)

(21) Appl. No.: 16/730,191

(22) Filed: Dec. 30, 2019

(51) Int. Cl. G01N 31/22

(52) U.S. Cl. CPC G01N 31/22

(57) ABSTRACT

A rapid detection method of sulfide content is provided, which includes determining the concentration and volume of a metal ion solution, the volume of a sample, and the amount of a chemical reducing agent, depending on a threshold value. It also provides preparing the metal ion solution, sampling the sample, and mixing the metal ion solution with the sample to result in a mixture solution. The chemical reducing agent is added into the mixture solution to obtain the resulting solution. Naked-eye observation of the resulting solution is used to determine whether the sulfide content of the sample is over the threshold value. When the resulting solution is clear, this indicates that the sulfide content of the sample is greater than or equal to the threshold value. When the resulting solution contains precipitates, this indicates that the sulfide content of the sample is lower than the threshold value.

### TECHNICAL FIELD

The disclosure relates to a method for confirming whether the sulfide content in a sample exceeds the standard.

### BACKGROUND

Petrochemical products are widely used in daily life, but due to the limitations of current technology, sulfides are formed in the manufacturing process of petroleum products; or for safety, sulfides are often added to odorless liquefied petroleum gas and natural gas. However, when the sulfide content is too high, this will not only cause air pollution, but also increase the risk of carcinogenesis. Therefore, there are regulatory standards for sulfide content worldwide.

Sulfide content measured in the laboratory or on-site rapid screening, requires a certain analysis cost. Looking at Taiwan's 2500 gas stations as an example, quick and regular screening of 92, 95, 98 unleaded gasoline and diesel at each gas station would require tens of thousands of samples every year, which would be costly and time consuming. Therefore, there is an urgent need for a new rapid screening technology to reduce the cost of screening and to more quickly confirm whether the sulfide content in the oil product exceeds the standard.

### SUMMARY

According to an embodiment of the disclosure, the disclosure provides a method for rapid detection of sulfide content, comprising: determining the concentration and volume of a metal ion solution, the volume of a sample, and the amount of a chemical reducing agent, based on a threshold value; providing the metal ion solution, sampling the sample, and mixing the metal ion solution with the sample to form a mixture solution; adding the chemical reducing agent to the to the mixture solution to obtain a rapid detection result; observing the rapid detection result to check whether the sulfide content of the sample is over the threshold value, wherein the rapid detection result is clear when the sulfide content of the sample is greater than or equal to the threshold value, and the rapid detection result is precipitated when the sulfide content of the sample is less than the threshold value.

The foregoing will become better understood from a careful reading of a detailed description provided herein below.

### DETAILED DESCRIPTION

According to an embodiment of the disclosure, the disclosure provides a method for rapid detection of sulfide content, comprising: determining the concentration and volume of a metal ion solution, the volume of a sample, and the amount of a chemical reducing agent, based on a threshold value. For example, commercially available metal salts can be prepared into different volume metal ion solutions. In one embodiment, the metal ion may be a gold ion, silver ion, copper ion, chromium ions, cadmium ion, others metal ions capable of being prepared into nanoparticles, or a combination thereof. When the metal ion is a gold ion, the metal salt may be chloroauric acid, gold (Ill) chloride (also called auric chloride), or other suitable gold ions. When the metal ion is a silver ion, the metal salt may be silver chloride, silver nitrate, or other suitable silver ion. When the metal ion is a copper ion, the metal salt may be copper sulfate, copper acetate, copper nitrate, or other suitable copper ions. When the metal ion is a cadmium ion, the metal salt may be cadmium selenide, cadmium acetate, or other suitable cadmium ions.

Preparing an oil product of sulfur compounds at a specific concentration (the so-called threshold value) and determining the volume of the oil product. For different volumes of metal ion solutions, prepare the chemical reducing agents respectively, which can completely chemically reduce the metal ions of the metal ion solution to metal atoms, that is, confirm the amount of chemical reducing agent. In one embodiment, the chemical reducing agent may be sodium borohydride, sodium citrate, or other suitable aqueous solution of chemical reducing agents. Next, take a fixed volume of oil product and mix with different volumes of metal ion solution to form a mixture solution. Then add the chemical reducing agent to the mixture solution to confirm whether precipitation occurred or not.

The volume of metal ion solution is confirmed from a small volume to a large volume, once it is found that the mixture solution of a specific volume of metal ion solution and a fixed volume of oil product is clear (non-precipitated) after adding a chemical reducing agent, the specific volume of the metal ion solution can be used for the rapid detection of oil product to determine whether the sulfide content exceeds the threshold value. It can be understood that the concentration and volume of the above-mentioned metal ion solution, the fixed volume of the oil product, and the amount of chemical reducing agent are not limited to any specific value, and the design can be adjusted to meet the needs of the user. The above steps for confirming the volume and concentration of the metal ion solution, the sampling volume of the sample, and the amount of chemical reducing agent are just examples, and those with ordinary knowledge in the art can adopt other logical steps to achieve the above purpose.

A specific volume and a specific concentration of metal ion solution can then be provided, and a fixed volume of the sample can be sampled. The metal ion solution is mixed with the sample to form a mixture solution. A chemical reducing agent is added to the mixture solution to obtain a rapid detection result. Observe the rapid detection result to check whether the sulfide content of the sample over the threshold value. The rapid detection result is clear when the sulfide content of the sample is greater than or equal to the threshold value, and the rapid detection result is precipitated when the sulfide content of the sample is less than the threshold value. In one embodiment, the sample includes petrochemical products, such as oil products or solvents. For example, the oil products may be unleaded gasoline, diesel oil, liquefied petroleum gas, or other suitable oil products. And the solvents may be ethanol, isopropanol, propylene glycol methyl ether, propylene glycol methyl ether acetate, n-butyl acetate, cyclopentanone, acetone, N-methylpyrrolidone, or other suitable solvents.

In one embodiment, the threshold value is between 0.1 ppmw and 30,000 ppmw. If the threshold value is too low, even if the sulfide content of the sample does not exceed the threshold value, the concentration of gold atoms generated by reducing gold ions may be too low to cause precipitation. If the threshold value is too high, the amount of metal ions used in the rapid detection of sulfide content may be too high, which increases costs. For samples with high sulfide content, consider diluting the sample first and then performing the rapid detection to reduce the threshold value.

In one embodiment, the volume of the metal ion solution is between 1 mL and 30 mL, and the concentration of the metal ion solution is between 1M and 10⁻¹⁰M. If the volume of metal ion solution is too small, it is difficult to observe the precipitation. If the volume of the metal ion solution is too large, the total volume of the rapid-detection kit will increase, and the shipping cost will also increase. If the concentration of metal ion solution is too low, even if the sulfide content of the sample does not exceed the threshold value, the concentration of gold atoms generated by reducing gold ions may be too low to cause precipitation. If the concentration of the metal ion solution is too high, the samples will all have precipitation reactions and cause misjudgment.

In one embodiment, the volume of the sample is between 1 mL and 30 mL. If the sampling volume of the sample is too small, it will easily cause sampling errors. If the sampling volume of the sample is too large, the amount of metal ions will increase and the cost will also increase.

In one embodiment, the rapid detection method for sulfide content described above lasted less than 10 minutes; for example, it may have lasted 3 minutes, or 5 minutes. The rapid detection method in this disclosure may greatly reduce the detection time compared with common sulfide content detection methods currently in use. In one embodiment, the sulfide comprises hydrogen sulfide, thiol, thioether, thiophene, persulfide, polycyclic thiophene, a combination thereof and the like, but they are not limited thereto. Moreover, in one embodiment, the functional group of the sulfide comprises sulfonyl group, sulfonic group, sulfinyl group, mercapto group, thiocyanate, disulfide bond, a combination thereof and the like, but they are not limited thereto.

The key of this disclosure is the sequence of detection steps of. The metal ion solution must be mixed with the sample before adding a chemical reducing agent to confirm whether the rapid detection result is precipitated. If the metal ion solution and the chemical reducing agent are mixed first, the precipitation depends on the concentration of the metal ion solution, and is not related to the sulfide content of the sample. For example, if a metal ion solution is mixed with a chemical reducing agent first, and a precipitate is generated, even if the sulfide content of the oil product added later exceeds the threshold value, the precipitate will not disappear.

In order to make the above content and other objects, features, and advantages of the present disclosure more comprehensible, the following describes the preferred embodiments in detail, as follows:

### EXAMPLES

### Example 1

The commercially available chloroauric acid was prepared into different volumes of gold ion solutions. An oil product with a sulfide compound concentration of 9.6 ppmw was also prepared. For different volumes of gold ion solutions, the respective chemical reducing agents were prepared (i.e. sodium borohydride solution), which could completely chemically reduce the gold ions of the gold ion solution to gold atoms. A fixed volume of oil products was mixed with different volumes of gold ion solution to form a mixture solution, and then a chemical reducing agent was added to confirm whether precipitation occurred or not. The volume of gold ion solution was confirmed from a small volume to a large volume, once it was found that the mixture solution of a specific volume of gold ion solution and a fixed volume of oil product was clear (non-precipitated) after adding a chemical reducing agent, the specific volume of the gold ion solution could be used for the rapid detection of oil product with a threshold value of 9.6 ppmw. It should be understood that the concentration and volume of the above-mentioned gold ion solution, the fixed volume of the oil product, and the amount of chemical reducing agent were not limited to any specific value, and the design could be adjusted to meet the needs of the user.

Diesel oil and biodiesel were taken as samples, the sulfide content of the samples was measured by a portable X-ray machine or by standard measurement method ASTM D5453. A fixed volume of the sample was added to the above-mentioned gold ion solution to form a mixture solution, then a chemical reducing agent was added to the mixture solution to observe whether the rapid detection result was precipitated. The sulfide content of diesel is regulated to 10 ppmw, and the threshold value set by the above-mentioned rapid detection method was 9.6 ppmw. The detection results are shown in Table 1.

TABLE 1

| | Portable X-ray | | | | |
|---|---|---|---|---|---|
| | machine | | ASTM D5453 | | Gold ion solution |
| Detection cost | 1000NTD | | 8000NTD | | <100NTD |
| Detection time | 5 | minutes | 12 | minutes | 3 minutes |
| Diesel oil -1 | 3.9 | ppmw | 6.4 | ppmw | Precipitated |
| | | | | | (<threshold value) |
| Diesel oil -2 | 5.3 | ppmw | 4.4 | ppmw | Precipitated |
| | | | | | (<threshold value) |
| Biodiesel -1 | 8.8 | ppmw | 7.9 | ppmw | Precipitated |
| | | | | | (<threshold value) |
| Biodiesel -2 | 8.0 | ppmw | 7.1 | ppmw | Precipitated |
| | | | | | (<threshold value) |
| Control of diesel | 9.2 | ppmw | 9.0 | ppmw | Precipitated |
| oil-1 | | | | | (<threshold value) |
| Control of diesel | 11.0 | ppmw | 10.5 | ppmw | Clear |
| oil-2 | | | | | (<threshold value) |

It can be seen in Table 1 that the method of mixing the gold ion solution with the oil product first, and then adding a chemical reducing agent to observe whether a precipitate is generated to confirm whether the sulfide content in the oil product exceeds the threshold value, had obvious advantages such as rapidness, reliability, and significant cost reduction.

### Example 2

The commercially available chloroauric acid was prepared into different volumes of gold ion solutions. An oil product with a sulfide compound concentration of 9.6 ppmw was also prepared. For different volumes of gold ion solutions, the respective chemical reducing agents were prepared (i.e. sodium borohydride solution), which could completely chemically reduce the gold ions of the gold ion solution to gold atoms. A fixed volume of oil products was mixed with different volumes of gold ion solution to form a mixture solution, and then a chemical reducing agent was added to confirm whether precipitation occurred or not. The volume of gold ion solution was confirmed from a small volume to a large volume, once it was found that the mixture solution of a specific volume of gold ion solution and a fixed volume of oil product was clear (non-precipitated) after adding a chemical reducing agent, the specific volume of the gold ion solution could be used for the rapid detection of oil product with a threshold value of 9.6 ppmw. It should be understood that the concentration and volume of the above-mentioned gold ion solution, the fixed volume of the oil product, and the amount of chemical reducing agent were not limited to any specific value, and the design could be adjusted to meet the needs of the user.

Unleaded gasoline was taken as samples, the sulfide content of the sample was measured by standard measurement method ASTM D5453. A fixed volume of the sample was added to the above-mentioned gold ion solution to form a mixture solution, then a chemical reducing agent was added to the mixture solution to observe whether the rapid detection result was precipitated. The sulfide content of unleaded gasoline is regulated to 10 ppmw, and the threshold value set by the above-mentioned rapid detection method was 9.6 ppmw. The detection results are shown in Table 2.

TABLE 2

| | ASTM D5453 | | Gold ion solution |
|---|---|---|---|
| Detection cost | 8000NTD | | <100NTD |
| Detection time | 12 | minutes | 3 minutes |
| 92 unleaded gasoline-1 | 2.2 | ppmw | Precipitated |
| | | | (<threshold value) |
| 92 unleaded gasoline-2 | 7.6 | ppmw | Precipitated |
| | | | (<threshold value) |
| 95 unleaded gasoline-1 | 3.3 | ppmw | Precipitated |
| | | | (<threshold value) |
| 95 unleaded gasoline-2 | 7.6 | ppmw | Precipitated |
| | | | (<threshold value) |
| 98 unleaded gasoline-1 | 3.0 | ppmw | Precipitated |
| | | | (<threshold value) |
| 98 unleaded gasoline-4 | 5.1 | ppmw | Precipitated |
| | | | (<threshold value) |
| Control of unleaded gasoline-1 | 9.0 | ppmw | Precipitated |
| | | | (<threshold value) |
| Control of unleaded gasoline-2 | 11.1 | ppmw | Clear |
| | | | (>threshold value) |

It can be seen in Table 2 that the method of mixing the gold ion solution with the unleaded gasoline first, and then adding a chemical reducing agent to observe whether a precipitate is generated to confirm whether the sulfide content in the oil product exceeds the threshold value, had obvious advantages such as rapidness, reliability, and significant cost reduction.

### Example 3

The commercially available chloroauric acid was prepared into different volumes of gold ion solutions. An oil product with a sulfide compound concentration of 45 ppmw was also prepared. For different volumes of gold ion solutions, the respective chemical reducing agents were prepared (i.e. sodium borohydride solution), which could completely chemically reduce the gold ions of the gold ion solution to gold atoms. A fixed volume of oil products was mixed with different volumes of gold ion solution to form a mixture solution, and then a chemical reducing agent was added to confirm whether precipitation occurred or not. The volume of gold ion solution was confirmed from a small volume to a large volume, once it was found that the mixture solution of a specific volume of gold ion solution and a fixed volume of oil product was clear (non-precipitated) after adding a chemical reducing agent, the specific volume of the gold ion solution could be used for the rapid detection of oil product with a threshold value of 45 ppmw. It should be understood that the concentration and volume of the above-mentioned gold ion solution, the fixed volume of the oil product, and the amount of chemical reducing agent were not limited to any specific value, and the design could be adjusted to meet the needs of the user.

Liquefied petroleum gas was taken as samples, the sulfide content of the samples were measured by a portable gas chromatograph (GC) or by standard measurement method ASTM D6667. A fixed volume of the sample was added to the above-mentioned gold ion solution to form a mixture solution, then a chemical reducing agent was added to the mixture solution to observe whether the rapid detection result was precipitated. The sulfide content of liquefied petroleum gas is regulated to 50 ppmw, and the threshold value set by the above-mentioned rapid detection method was 45 ppmw. The detection results are shown in Table 3.

TABLE 3

| | Portable GC | | ASTM D6667 | | Gold ion solution |
|---|---|---|---|---|---|
| Detection cost | 8000NTD | | 8000NTD | | <100NTD |
| Detection time | 15 | minutes | 12 | minutes | 3 minutes |
| Liquefied petroleum | 20 | ppmw | 23 | ppmw | Precipitated |
| gas-1 | | | | | (<threshold value) |
| Liquefied petroleum | 17 | ppmw | 23 | ppmw | Precipitated |
| gas-2 | | | | | (<threshold value) |
| Liquefied petroleum | 18 | ppmw | 24 | ppmw | Precipitated |
| gas-3 | | | | | (<threshold value) |
| Liquefied petroleum | 19 | ppmw | 21 | ppmw | Precipitated |
| gas-4 | | | | | (<threshold value) |

| | | | | |
|---|---|---|---|---|
| Control of liquefied | Not tested | 25 | ppmw | Precipitated |
| petroleum gas-1 | | | | (<threshold value) |
| Control of liquefied | Not tested | 50 | ppmw | Clear |
| petroleum gas-2 | | | | (>threshold value) |

It can be seen in Table 3 that the method of mixing the gold ion solution with the liquefied petroleum gas first, and then adding a chemical reducing agent to observe whether a precipitate is generated to confirm whether the sulfide content in the liquefied petroleum gas exceeds the threshold value, had obvious advantages such as rapidness, reliability, and significant cost reduction.

### Example 4

Dissolved natural gas of known sulfide concentration in a fixed volume of solvent for a fixed time, and then confirmed the sulfide concentration in the solvent by standard measurement method ASTM D5504. In this way, the function of the sulfide concentration of the solvent, the sulfide concentration in the natural gas, the time the natural gas dissolved in the solvent, and the volume of the solvent could be calculated. The regulation of sulfide content of natural gas is 45 mg/m³. Used the above function to select the appropriate time and solvent volume for the natural gas to dissolve in the solvent to reach the threshold value of 40 mg/m³ of sulfide content.

The commercially available chloroauric acid was prepared into different volumes of gold ion solutions. The solvent with a sulfide compound concentration of 40 mg/m³ was also prepared. For different volumes of gold ion solutions, the respective chemical reducing agents were prepared (i.e. sodium borohydride solution), which could completely chemically reduce the gold ions of the gold ion solution to gold atoms. A fixed volume of oil products was mixed with different volumes of gold ion solution to form a mixture solution, and then a chemical reducing agent was added to confirm whether precipitation occurred or not. The volume of gold ion solution was confirmed from a small volume to a large volume, once it was found that the mixture solution of a specific volume of gold ion solution and a fixed volume of oil product was clear (non-precipitated) after adding a chemical reducing agent, the specific volume of the gold ion solution could be used for the rapid detection of the solvent with a threshold value of 40 mg/m³. It should be understood that the concentration and volume of the above-mentioned gold ion solution, the fixed volume of the solvent, and the amount of chemical reducing agent were not limited to any specific value, and the design could be adjusted to meet the needs of the user.

The sulfide content of natural gas was directly measured by a commercially available detector tube (brand: Gastec), or prepared the natural gas dissolved in a fixed volume of solvent for a fixed period of time as a sample, then the sulfide content of the sample was measured by the standard measurement method ASTM D5504. A fixed volume of the sample was added to the above-mentioned gold ion solution to form a mixture solution, then a chemical reducing agent was added to the mixture solution to observe whether the rapid detection result was precipitated. The measurement results are shown in Table 4.

TABLE 4

| | Detector tube | | ASTM D5504 | | Gold ion solution |
|---|---|---|---|---|---|
| Detection cost | 200NTD | | 8000NTD | | <100NTD |
| Detection time | 1 | minute | 15 | minutes | 3 minutes |
| Natural gas-1 | 11.1 | mg/m³ | 5.6 | mg/m³ | Precipitated |
| | | | | | (<threshold value) |
| Natural gas-2 | 11.1 | mg/m³ | 10.0 | mg/m³ | Precipitated |
| | | | | | (<threshold value) |
| Natural gas-3 | 3.6 | mg/m³ | 2.4 | mg/m³ | Precipitated |
| | | | | | (<threshold value) |
| Natural gas-4 | 9.1 | mg/m³ | 3.9 | mg/m³ | Precipitated |
| | | | | | (<threshold value) |

| | | | | |
|---|---|---|---|---|
| Control of natural | Not tested | 38.9 | mg/m³ | Precipitated |
| gas-1 | | | | (<threshold value) |
| Control of natural | Not tested | 45.8 | mg/m³ | Clear |
| gas-2 | | | | (>threshold value) |

It can be seen in Table 4 that the method of mixing the gold ion solution with the solvent dissolved sulfide compounds of natural gas first, and then adding a chemical reducing agent to observe whether a precipitate is generated to confirm whether the sulfide content in the natural gas exceeds the threshold value, had obvious advantages such as rapidness, reliability, and significant cost reduction.

### Example 5

The commercially available chloroauric acid was prepared into different volumes of gold ion solutions. The solvent with a sulfide compound concentration of 0.45 ppmw was also prepared. For different volumes of gold ion solutions, the respective chemical reducing agents were prepared (i.e. sodium borohydride solution), which could completely chemically reduce the gold ions of the gold ion solution to gold atoms. A fixed volume of solvent was mixed with different volumes of gold ion solution to form a mixture solution, and then a chemical reducing agent was added to confirm whether precipitation occurred or not. The volume of gold ion solution was confirmed from a small volume to a large volume, once it was found that the mixture solution of a specific volume of gold ion solution and a fixed volume of solvent was clear (non-precipitated) after adding a chemical reducing agent, the specific volume of the gold ion solution could be used for the rapid detection of the solvent with a threshold value of 0.45 ppmw. It should be understood that the concentration and volume of the above-mentioned gold ion solution, the fixed volume of the solvent, and the amount of chemical reducing agent were not limited to any specific value, and the design could be adjusted to meet the needs of the user.

Ethanol or isopropanol with different concentrations of sulfide content were prepared separately as samples. A fixed volume of the sample was added to the above-mentioned gold ion solution to form a mixture solution, then a chemical reducing agent was added to the mixture solution to observe whether the rapid detection result was precipitated. The threshold value set by the above-mentioned rapid detection method was 0.45 ppmw. The measurement results are shown in Table 5.

TABLE 5

| | Sulfide content | Gold ion solution |
|---|---|---|
| Ethanol | 0.1 ppmw | Precipitated |
| | | (<threshold value) |
| | 0.5 ppmw | Clear |
| | | (>threshold value) |
| | 1.0 ppmw | Clear |
| | | (>threshold value) |
| Isopropanol | 0.1 ppmw | Precipitated |
| | | (<threshold value) |
| | 0.5 ppmw | Clear |
| | | (>threshold value) |
| | 1.0 ppmw | Clear |
| | | (>threshold value) |

It can be seen in Table 5 that it can be confirmed by the gold ion solution whether the sulfide content in the sample exceeds an extremely low threshold value (such as 0.1 ppmw).

### Example 6

The commercially available silver nitrate was prepared into different volumes of silver ion solutions. An oil product with a sulfide compound concentration of 0.45 ppmw was also prepared. For different volumes of silver ion solutions, the respective chemical reducing agents were prepared (i.e. sodium borohydride solution), which could completely chemically reduce the silver ions of the silver ion solution to silver atoms. A fixed volume of oil product was mixed with different volumes of silver ion solution to form a mixture solution, and then a chemical reducing agent was added to confirm whether precipitation occurred or not. The volume of silver ion solution was confirmed from a small volume to a large volume, once it was found that the mixture solution of a specific volume of silver ion solution and a fixed volume of oil product was clear (non-precipitated) after adding a chemical reducing agent, the specific volume of the silver ion solution could be used for the rapid detection of oil product with a threshold value of 0.45 ppmw. It should be understood that the concentration and volume of the above-mentioned silver ion solution, the fixed volume of the oil product, and the amount of chemical reducing agent were not limited to any specific value, and the design could be adjusted to meet the needs of the user.

Ethanol or isopropanol with different concentrations of sulfide content were prepared separately as samples. A fixed volume of the sample was added to the above-mentioned silver ion solution to form a mixture solution, then a chemical reducing agent was added to the mixture solution to observe whether the rapid detection result was precipitated. The threshold value set by the above-mentioned rapid detection method was 0.45 ppmw. The measurement results are shown in Table 6.

TABLE 6

| | Sulfide content | Silver ion solution |
|---|---|---|
| Ethanol | 0.1 ppmw | Precipitated |
| | | (<threshold value) |
| | 0.5 ppmw | Clear |
| | | (>threshold value) |
| | 1.0 ppmw | Clear |
| | | (>threshold value) |
| Isopropanol | 0.1 ppmw | Precipitated |
| | | (<threshold value) |
| | 0.5 ppmw | Clear |
| | | (>threshold value) |
| | 1.0 ppmw | Clear |
| | | (>threshold value) |

It can be seen in Table 6 that it can be confirmed by the silver ion solution whether the sulfide content in the sample exceeds an extremely low threshold value (such as 0.45 ppmw).

### Example 7

The commercially available copper nitrate was prepared into different volumes of silver ion solutions. The solvent with a sulfide compound concentration of 0.45 ppmw was also prepared. For different volumes of copper ion solutions, the respective chemical reducing agents were prepared (i.e. sodium borohydride solution), which could completely chemically reduce the copper ions of the copper ion solution to copper atoms. A fixed volume of solvent was mixed with different volumes of copper ion solution to form a mixture solution, and then a chemical reducing agent was added to confirm whether precipitation occurred or not. The volume of copper ion solution was confirmed from a small volume to a large volume, once it was found that the mixture solution of a specific volume of copper ion solution and a fixed volume of solvent was clear (non-precipitated) after adding a chemical reducing agent, the specific volume of the copper ion solution could be used for the rapid detection of the solvent with a threshold value of 0.45 ppmw. It should be understood that the concentration and volume of the above-mentioned copper ion solution, the fixed volume of the solvent, and the amount of chemical reducing agent were not limited to any specific value, and the design could be adjusted to meet the needs of the user.

Ethanol or isopropanol with different concentrations of sulfide content were prepared separately as samples. A fixed volume of the sample was added to the above-mentioned copper ion solution to form a mixture solution, then a chemical reducing agent was added to the mixture solution to observe whether the rapid detection result was precipitated. The threshold value set by the above-mentioned rapid detection method was 0.45 ppmw. The measurement results are shown in Table 7.

TABLE 7

| | Sulfide content | Copper ion solution |
|---|---|---|
| Ethanol | 0.1 ppmw | Precipitated |
| | | (<threshold value) |
| | 0.5 ppmw | Clear |
| | | (>threshold value) |
| | 1.0 ppmw | Clear |
| | | (>threshold value) |
| Isopropanol | 0.1 ppmw | Precipitated |
| | | (<threshold value) |
| | 0.5 ppmw | Clear |
| | | (>threshold value) |
| | 1.0 ppmw | Clear |
| | | (>threshold value) |

It can be seen in Table 7 that it can be confirmed by the copper ion solution whether the sulfide content in the sample exceeds an extremely low threshold value (such as 0.45 ppmw).

### Example 8

The commercially available cadmium nitrate was prepared into different volumes of silver ion solutions. The solvent with a sulfide compound concentration of 0.45 ppmw was also prepared. For different volumes of cadmium ion solutions, the respective chemical reducing agents were prepared (i.e. sodium borohydride solution), which could completely chemically reduce the cadmium ions of the cadmium ion solution to cadmium atoms. A fixed volume of solvent was mixed with different volumes of cadmium ion solution to form a mixture solution, and then a chemical reducing agent was added to confirm whether precipitation occurred or not. The volume of cadmium ion solution was confirmed from a small volume to a large volume, once it was found that the mixture solution of a specific volume of cadmium ion solution and a fixed volume of solvent was clear (non-precipitated) after adding a chemical reducing agent, the specific volume of the cadmium ion solution could be used for the rapid detection of the solvent with a threshold value of 0.45 ppmw. It should be understood that the concentration and volume of the above-mentioned cadmium ion solution, the fixed volume of the solvent, and the amount of chemical reducing agent were not limited to any specific value, and the design could be adjusted to meet the needs of the user.

Ethanol or isopropanol with different concentrations of sulfide content were prepared separately as samples. A fixed volume of the sample was added to the above-mentioned cadmium ion solution to form a mixture solution, then a chemical reducing agent was added to the mixture solution to observe whether the rapid detection result was precipitated. The threshold value set by the above-mentioned rapid detection method was 0.45 ppmw. The measurement results are shown in Table 8.

TABLE 8

| | Sulfide content | Cadmium ion solution |
|---|---|---|
| Ethanol | 0.1 ppmw | Precipitated |
| | | (<threshold value) |
| | 0.5 ppmw | Clear |
| | | (>threshold value) |
| | 1.0 ppmw | Clear |
| | | (>threshold value) |
| Isopropanol | 0.1 ppmw | Precipitated |
| | | (<threshold value) |
| | 0.5 ppmw | Clear |
| | | (>threshold value) |
| | 1.0 ppmw | Clear |
| | | (>threshold value) |

It can be seen in Table 8 that it can be confirmed by the cadmium ion solution whether the sulfide content in the sample exceeds an extremely low threshold value (such as 0.45 ppmw).

It will be apparent to those skilled in the art that various modifications and variations can be made to the disclosed embodiments. It is intended that the specification and examples be considered as examples only, with the true scope of the disclosure being indicated by the following claims and their equivalents.

What is claimed is:

1. A method for rapid detection of sulfide content, comprising:
determining a concentration and volume of a metal ion solution, a volume of a sample, and an amount of a chemical reducing agent based on a threshold value;
providing the metal ion solution, sampling the sample, and mixing the metal ion solution with the sample to form a mixture solution;
adding the chemical reducing agent to the mixture solution to obtain a rapid detection result;
observing the rapid detection result to check whether the sulfide content of the sample is over the threshold value,
wherein the rapid detection result is clear when the sulfide content of the sample is greater than or equal to the threshold value, and the rapid detection result is precipitated when the sulfide content of the sample is less than the threshold value.

2. The method as claimed in claim 1, wherein the metal ions of the metal ion solution comprise gold ions, silver ions, copper ions, chromium ions, cadmium ions or a combination thereof.

3. The method as claimed in claim 1, wherein the chemical reducing agent comprises sodium borohydride, sodium citrate, or a combination thereof.

4. The method as claimed in claim 1, wherein the threshold value is between 0.1 ppmw and 30,000 ppmw.

5. The method as claimed in claim 1, wherein the chemical reducing agent completely reduces the metal ions into metal atoms in the metal ion solution.

6. The method as claimed in claim 1, wherein the sample comprises petrochemicals.

7. The method as claimed in claim 1, wherein the volume of the metal ion solution is between 1 mL and 30 mL.

8. The method as claimed in claim 1, wherein the concentration of the metal ion solution is between 1M and 10⁻¹⁰M.

9. The method as claimed in claim 1, wherein the volume of the sample is between 1 mL and 30 mL.

10. The method as claimed in claim 1, being lasted less than 10 minutes.

11. The method as claimed in claim 1, wherein the sulfide comprises hydrogen sulfide, thiol, thioether, thiophene, persulfide, polycyclic thiophene or a combination thereof.

12. The method as claimed in claim 1, wherein the functional group of the sulfide comprises sulfonyl group, sulfonic group, sulfinyl group, mercapto group, thiocyanate, disulfide bond or a combination thereof.
